(19) United States
(12) Patent Application Publication
(10) Pub. No.: US 2013/0093603 A1
(43) Pub. Date: Apr. 18, 2013

(54) VEHICLE SYSTEM AND METHOD FOR ASSESSING AND COMMUNICATING A CONDITION OF A DRIVER

(71) Applicants: Michael Dean Tschirhart, Ann Arbor, MI (US); Upton Beall Bowden, Canton, MI (US); Michael Eichbrecht, Farmington Hills, MI (US)

(72) Inventors: Michael Dean Tschirhart, Ann Arbor, MI (US); Upton Beall Bowden, Canton, MI (US); Michael Eichbrecht, Farmington Hills, MI (US)

(73) Assignee: VISTEON GLOBAL TECHNOLOGIES, INC., Van Buren Twp., MI (US)

(21) Appl. No.: 13/275,922

(22) Filed: Oct. 18, 2011

(51) Int. Cl. G08B 21/02

(52) U.S. Cl. 340/902

(57) ABSTRACT

A vehicle system includes at least one communication device to communicate various states of a condition of a driver, at least one sensor for detecting at least one characteristic of at least one of the driver and the vehicle, wherein the at least one sensor generates a sensor signal representing the at least one characteristic of the at least one of the driver and the vehicle; and a processor in communication with the at least one sensor and the at least one communication device, wherein the processor receives the sensor signal, analyzes the sensor signal based upon an instruction set to determine the condition of the driver, and controls the at least one communication device based upon the at least one characteristic of the at least one of the driver and the vehicle to communicate the various states of the condition of the driver to other vehicles.

### FIELD OF THE INVENTION

The present invention relates generally to a vehicle system. In particular, the invention is directed to a vehicle system and method for assessing a condition of a driver and continuously communicating the condition of the driver to others outside of the vehicle.

### BACKGROUND OF THE INVENTION

It is well known that countless injuries and fatalities are caused each year by vehicle accidents resulting from impairment of driving ability of a driver of the vehicle, which may arise from a number of different causes. Many such accidents are caused when drivers have driven too long without sleep, and begin to fall asleep while operating the vehicle, often without realizing the impairment of the driving ability. Even if the driver does not actually fall completely asleep, the driver in the drowsy state will have substantially impaired alertness and reflexes, and may be unable to respond in time to hazards encountered while operating the vehicle.

There are a variety of other physical conditions which may impair the driving ability of the driver such as intoxication, diabetes, epilepsy, and narcolepsy, for example. Such physical conditions may cause the driver to suddenly black out, have a seizure, or fall asleep, sometimes without warning. Similarly, there are a number of unexpected health conditions which may suddenly, without warning, impair the driving ability of the driver such as a heart attack, a stroke, or an aneurysm, for example. In many instances, early warning signs of serious driver impairment can be detected. Examples of such warning signs can be a change in any of the following: an inclination of a head, a blinking pattern, a pupil dilation, a heart rate, and a blood pressure of the driver. Presently known vehicle systems monitor the head position of the driver to detect substantial operator impairment, and upon detecting impairment, activate safety devices to alert the driver or stop the vehicle. Yet, the extent to which the driver is impaired is often not known to others outside the vehicle or known only after occurrence of an undesired event such as lane deviation or a collision, for example. Receiving notification as early as possible of impairment of the driver is instrumental in providing adequate reaction time in the event evasive or other correct driving action is necessary.

Additionally, a “forward” driver observing an unexpected obstacle is unable to communicate that information to subsequent drivers except after a full information processing and handling cycle leads to brake-pedal application. In crisis situations, the time delay between observing the unexpected obstacle and applying the brake-pedal is critical. Subsequent drivers knowing that the forward driver is in distress could provide adequate time to react to another driver's behavior.

It would be desirable to develop a vehicle system and method which assesses a condition of the driver and continuously communicates the condition of the driver to others outside of the vehicle.

### SUMMARY OF THE INVENTION

In concordance and agreement with the present invention, a vehicle system and method which assesses a condition of the driver and continuously communicates the condition of the driver to others outside of the vehicle, has surprisingly been discovered.

In one embodiment, a system of a vehicle comprises: at least one communication device to communicate various states of a condition of a driver of the vehicle; at least one sensor for detecting at least one characteristic of at least one of the driver and the vehicle, the at least one sensor generating a sensor signal representing the at least one characteristic of the at least one of the driver and the vehicle; and a processor in communication with the at least one sensor and the at least one communication device, wherein the processor receives the sensor signal, analyzes the sensor signal based upon an instruction set to determine the condition of the driver, and controls the communication device based upon the condition of the driver to communicate the various states of the condition of the driver to other vehicles.

In another embodiment, a system of a vehicle comprises: a plurality of communication devices to communicate various states of a condition of a driver of the vehicle, wherein the communication devices are configured to generate at least one of an audible communication, a visual communication, and a wireless communication; at least one sensor for detecting at least one characteristic of at least one of the driver and the vehicle, the at least one sensor generating a sensor signal representing the at least one characteristic of the at least one of the driver and the vehicle; and a processor in communication with the at least one sensor and the communication devices, wherein the processor receives the sensor signal, analyzes the sensor signal based upon an instruction set to determine the condition of the driver, and controls the communication devices based upon the condition of the driver to continuously communicate the various states of the condition of the driver to other vehicles.

The invention also provides methods for communicating a condition of a driver of a vehicle.

One method comprises the steps of: providing a communication device to communicate various states of the condition of the driver of the vehicle; providing at least one sensor for detecting at least one characteristic of at least one of the driver and the vehicle, the at least one sensor generating a sensor signal representing the at least one characteristic of the at least one of the driver and the vehicle; and controlling the communication device based upon the at least one characteristic of the at least one of the driver and the vehicle to communicate the various states of the condition of the driver to other vehicles.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a vehicle system according to an embodiment of the invention;

FIG. 2 is a fragmentary schematic top plan view of a four-lane highway depicting a plurality of vehicles driving thereon, wherein one of the vehicles includes the vehicle system of FIG. 1; and

FIG. 3 is a fragmentary schematic perspective view of another one of the vehicles illustrated in FIG. 2 receiving a signal from the vehicle system of a forward vehicle.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

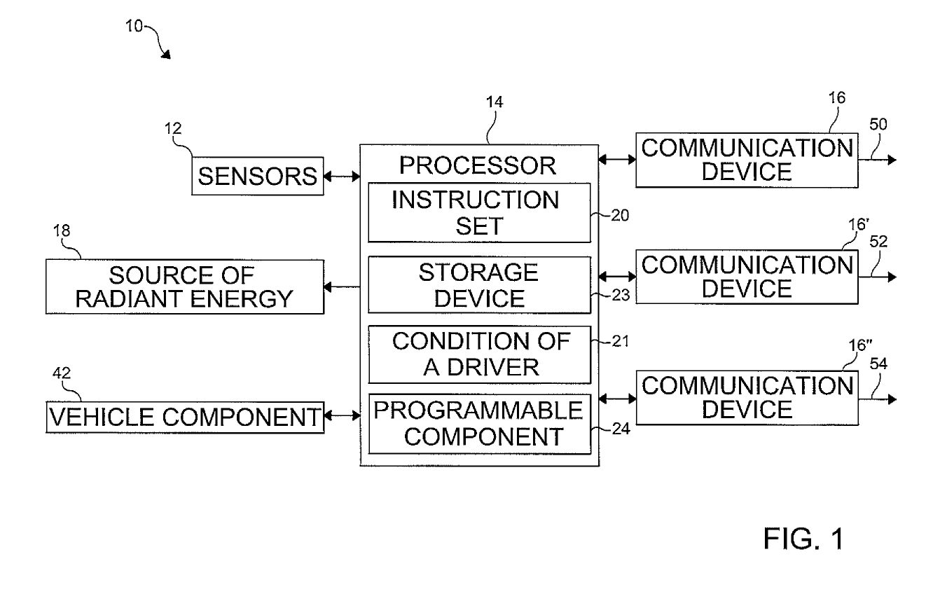

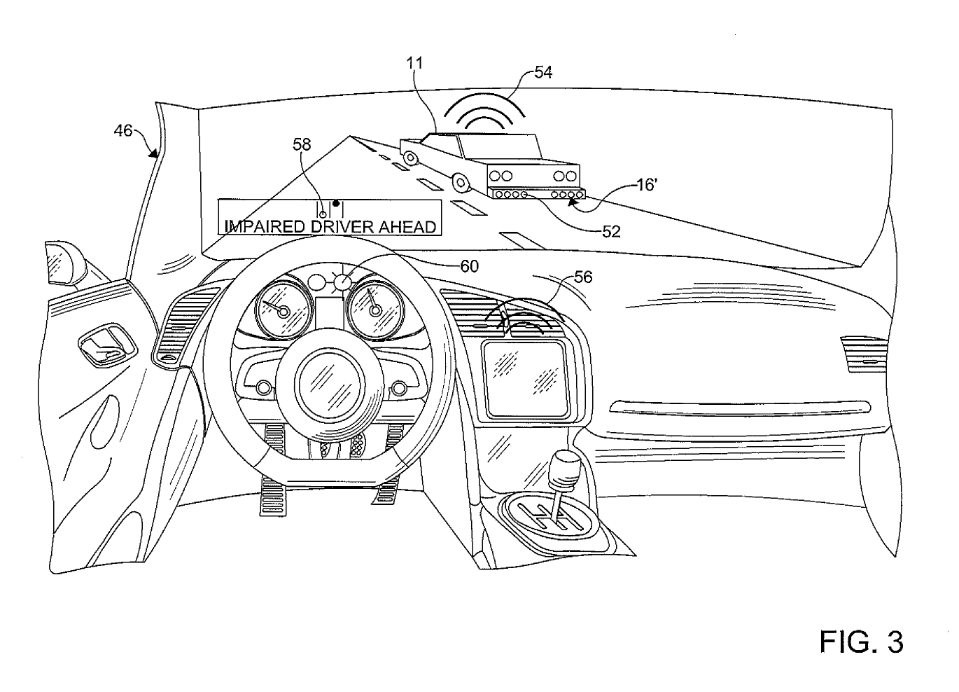

FIG. 1 illustrates a system 10 for a vehicle 11 (shown in FIG. 3) according to an embodiment of the present invention. As shown, the vehicle system 10 includes a plurality of sensors 12, a processor 14, and a plurality of communication devices 16, 16′, 16″. The vehicle system 10 can include any number of components and sub-components, as desired. The vehicle system 10 can be integrated in any user environment.

Each of the sensors 12 is a monitoring device capable of continuously detecting characteristics of the driver and/or characteristics of the vehicle 11. Examples of such characteristics of the driver include, but are not limited to, a vision characteristic of a face or head of the driver (e.g. a head pose, a head control, a gaze vector or direction, a pupil dilation, a blinking pattern, etc.) and a physiological or a behavioral biometric characteristic of the driver (e.g. a facial feature, a blood pressure, a heart rate, etc.). Examples of such characteristics of the vehicle 11 include, but are not limited to, a steering system characteristic (e.g. a steering wheel control), a braking system characteristic (e.g. a brake pedal application), an engine control system characteristic (e.g. an accelerator pedal application, a cruise control activation and deactivation, etc.) In certain embodiments, at least one of the sensors 12 is a complementary metal-oxide-semiconductor (CMOS) camera for capturing an image of at least a portion of a head (e.g. face or eyes) of the driver and generating a sensor signal representing the image. However, other cameras, image capturing devices, and the like can be used. The sensors 12 can be disposed in any suitable location and configuration in the vehicle 11. Suitable locations include, but are not limited to, a dashboard region, a center stack region, an overhead region, a seat region, and a steering wheel region of a passenger compartment of the vehicle 11, an engine compartment of the vehicle 11, at least one wheel compartment of the vehicle 11, and the like for example.

As a non-limiting example, a source of radiant energy 18 is disposed to illuminate at least a portion of a head of the driver. As a further non-limiting example, the source of radiant energy 18 may be an infra-red light emitting diode. However, other sources of the radiant energy can be used.

The processor 14 may be any device or system configured to receive an input signal (e.g. the sensor signal), analyze the input signal, and continuously control at least one of the communication devices 16, 16′, 16″ in response to the analysis of the input signal. In certain embodiments, the processor 14 is a micro-computer. In the embodiment shown, the processor 14 receives the input signal from at least one of the sensors 12.

As shown, the processor 14 analyzes the input signal based upon an instruction set 20. The instruction set 20, which may be embodied within any computer readable medium, includes processor executable instructions for configuring the processor 14 to perform a variety of tasks. The processor 14 may execute a variety functions such as controlling the operation of the sensors 12, the communication devices 16, 16′, 16″, and other vehicle components 42 (e.g. sensors, a climate control system, a navigation system, an entertainment system, a steering system, a fuel system, an electrical system, etc.), for example. It is understood that various algorithms and software can be used to analyze the characteristics of the driver and the characteristics of the vehicle. It is further understood that any software or algorithm can be used to detect the characteristics of the driver and the characteristics of the vehicle. As a non-limiting example, the instruction set 20 is a software configured to assess a condition of the driver 21 based upon the information received by the processor 14 (e.g. via the sensor signals). The condition of the driver 21 is any condition related to a distressed driver or an impairment of driving ability of the driver such as a high blood pressure, an increased heart rate, eyes closed, a gaze direction away from a direction of travel, and head nodding, for example.

In certain embodiments, the processor 14 includes a storage device 23. The storage device 23 may be a single storage device or may be multiple storage devices. Furthermore, the storage device 23 may be a solid state storage system, a magnetic storage system, an optical storage system, or any other suitable storage system or device. It is understood that the storage device 23 may be configured to store the instruction set 20. Other data and information may be stored and cataloged in the storage device 23 such as the data collected by the sensors 12, for example.

The processor 14 may further include a programmable component 24. It is understood that the programmable component 24 may be in communication with any other component of the vision system 10 such as the sensors 12 and the communication devices 16, 16′, 16″, for example. In certain embodiments, the programmable component 24 is configured to manage and control processing functions of the processor 14. Specifically, the programmable component 24 is configured to modify the instruction set 20 and control the analysis of the signals and information received by the processor 14. It is understood that the programmable component 24 may be configured to manage and control the sensors 12 and at least one of the communication devices 16, 16′, 16″. It is further understood that the programmable component 24 may be configured to store data and information on the storage device 23, and retrieve data and information from the storage device 23.

The communication device 16 is an audible device in communication with the processor 14. The communication device 16 can be any audible device configured to generate and transmit an audible communication 50 to other vehicles 46 or other people (not shown) outside of the vehicle 11. It is understood that the communication device 16 can be any communication device 16 which generates the audible communication 50 such as a horn or a siren, for example. It is further understood that the audible communication 50 can be a continuous or intermittent tone, if desired. In certain embodiments, characteristics of the audible communication 50 (e.g. a volume level and a length of the tone of the audible communication 50) can be based upon a state of the condition of the driver 21. For example, as the condition of the driver 21 worsens from a satisfactory state and a level of distress and/or impairment of the driver deviates from a normal state, the volume level and/or the length of the tone of the audible communication 50 increases from silence to a predetermined level and length of tone. Contrarily, as the condition of the driver 21 improves from an unsatisfactory state and the level of distress and/or impairment of the driver decreases to the normal state, the volume level and/or the length of the tone of the audible communication 50 decreases from the predetermined level and length of tone to silence.

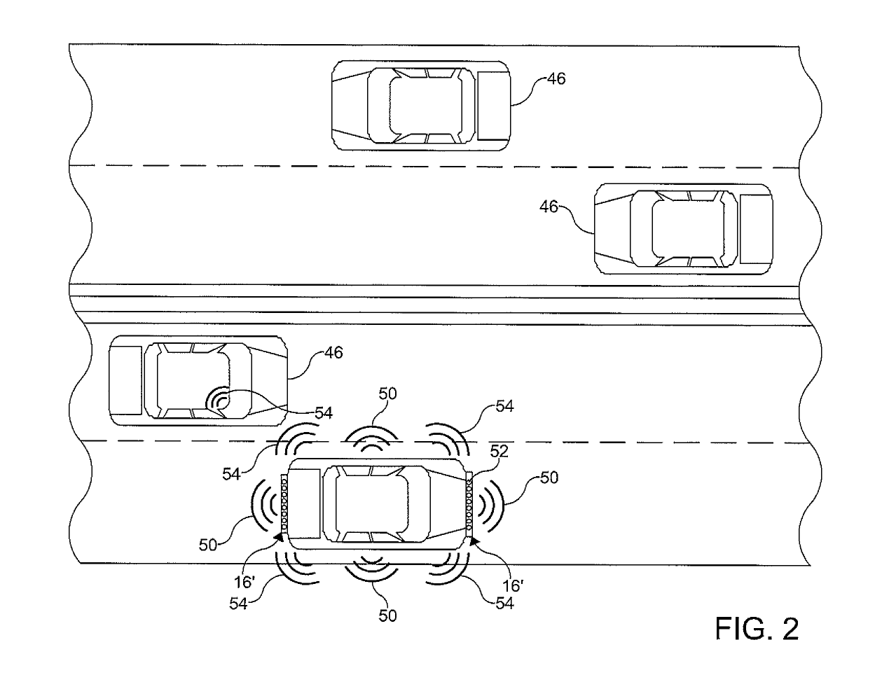

As shown in FIGS. 2-3, the communication device 16′ is a visual device in communication with the processor 14. The communication device 16′ can be any visual device configured to generate and transmit a visual communication 52 to other vehicles 46 or other people outside of the vehicle 11. It is understood that the communication device 16′ can be any communication device 16′ which generates a visual communication 52 such as at least one light bar on the vehicle, at least one headlight, at least one taillight, at least one passenger compartment light, and at least one backup light, for example. It is further understood that the visual communication 52 can be continuous or intermittent, if desired. In certain embodiments, characteristics of the visual communication 52 (e.g. an intensity level, a period of illumination, and a color of the visual communication 52) can be based upon the state of the condition of the driver 21. For example, as the condition of the driver 21 worsens from the satisfactory state and a level of distress and/or impairment of the driver deviates from a normal state, the intensity level and/or the period of illumination of the visual communication 52 increases from a normal state to a predetermined intensity level and/or period of illumination and the color of the visual communication 52 may change according to a predetermined color pattern (e.g. green to yellow to red). Contrarily, as the condition of the driver 21 improves from the unsatisfactory state and the level of distress and/or impairment of the driver decreases to the normal state, the intensity level and/or the period of illumination of the visual communication 52 decreases from the predetermined intensity level and/or period of illumination to the normal state, and the color of the visual communication 52 changes according to the predetermined color pattern (e.g. red to yellow to green).

The communication device 16″ is a wireless transmission device in communication with the processor 14. The communication device 16″ can be any wireless transmission device configured to generate and transmit a wireless communication 54 (i.e. a wireless signal) to other vehicles 46 or other people outside of the vehicle 11. It is understood that the communication device 16″ can be any transmitter, as desired. It is further understood that the wireless communication 54 can be received, analyzed, and output by any system of the other vehicles 46 outside of the vehicle 11 such as a vehicle audio system (not shown) configured to generate an audio warning 56, a vehicle navigation system (not shown) configured to generate a visual warning 58 (e.g. an impaired driver locator map 58), and an electrical system (not shown) configured to control a visual warning 60 (e.g. a dashboard light), for example. In certain embodiments, characteristics of the audio warning 56 (e.g. a volume level and a length of the tone of the audio warning 56), characteristics of the visual warning 58 (e.g. a size and period of display of the visual warning 58), and characteristics of the visual warning 60 (e.g. an intensity level, a period of illumination, and a color of the visual warning 60) can be based upon the state of the condition of the driver 21.

In operation, the sensors 12 continuously detect the characteristics of the driver and the vehicle, and thereby generate input signals based upon those characteristics. The processor 14 continuously receives the input signals (e.g. sensor signal) and information relating to the characteristics of the driver and the characteristics of the vehicle. The processor 14 analyzes the input signal and the information based upon the instruction set 20 to determine the condition of the driver 21. At least one of the communication devices 16, 16′, 16″ is controlled by the processor 14 based upon the state of the condition of the driver 21. As a non-limiting example, the processor 14 continuously transmits a control signal to at least one of the communication devices 16, 16′, 16″ to communicate the state of the condition of the driver 21 to other vehicles 46 and other people outside of the vehicle 11.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A system of a vehicle comprising:
at least one communication device to communicate various states of a condition of a driver of the vehicle;
at least one sensor for detecting at least one characteristic of at least one of the driver and the vehicle, the at least one sensor generating a sensor signal representing the at least one characteristic of the at least one of the driver and the vehicle; and
a processor in communication with the at least one sensor and the at least one communication device, wherein the processor receives the sensor signal, analyzes the sensor signal based upon an instruction set to determine the condition of the driver, and controls the at least one communication device based upon the condition of the driver to communicate the various states of the condition of the driver to other vehicles.

2. The system according to claim 1, wherein the at least one communication device includes an audible device configured to transmit an audible communication to the other vehicles.

3. The system according to claim 2, wherein at least one characteristic of the audible communication is based upon at least one state of the condition of the driver.

4. The system according to claim 1, wherein the at least one communication device includes a visual device configured to transmit a visual communication to the other vehicles.

5. The system according to claim 4, wherein at least one characteristic of the visual communication is based upon at least one state of the condition of the driver.

6. The system according to claim 1, wherein the at least one communication device includes a wireless transmission device configured to transmit a wireless communication to the other vehicles.

7. The system according to claim 6, wherein the wireless communication can be received, analyzed, and output by at least one system of the other vehicles.

8. The system according to claim 6, wherein at least one characteristic of the wireless communication is based upon at least one state of the condition of the driver.

9. The system according to claim 1, wherein the at least one communication device continuously communicates the various states of the condition of the driver to the other vehicles.

10. The system according to claim 1, wherein the at least one sensor detects at least one of a vision characteristic of the driver, a physiological biometric characteristic of the driver, a behavioral biometric characteristic of the driver, a steering system characteristic of the vehicle, a braking system characteristic of the vehicle, and an engine control system characteristic of the vehicle.

11. The system according to claim 1, wherein the instruction set is a software for determining the condition of the driver based upon the at least one characteristic of the at least one of the driver and the vehicle.

12. A system of a vehicle comprising:
a plurality of communication devices to communicate various states of a condition of a driver of the vehicle, wherein the communication devices are configured to generate at least one of an audible communication, a visual communication, and a wireless communication;
at least one sensor for detecting at least one characteristic of at least one of the driver and the vehicle, the at least one sensor generating a sensor signal representing the at least one characteristic of the at least one of the driver and the vehicle; and
a processor in communication with the at least one sensor and the communication devices, wherein the processor receives the sensor signal, analyzes the sensor signal based upon an instruction set to determine the condition of the driver, and controls the communication devices based upon the condition of the driver to continuously communicate the various states of the condition of the driver to other vehicles.

13. The system according to claim 12, wherein at least one characteristic of at least one of the audible communication, the visual communication, and the wireless communication is based upon at least one state of the condition of the driver.

14. The system according to claim 12, wherein the wireless communication can be received, analyzed, and output by at least one system of the other vehicles.

15. The system according to claim 12, wherein the at least one sensor detects at least one of a vision characteristic of the driver, a physiological biometric characteristic of the driver, a behavioral biometric characteristic of the driver, a steering system characteristic of the vehicle, a braking system characteristic of the vehicle, and an engine control system characteristic of the vehicle.

16. A method of communicating a condition of a driver of a vehicle, the method comprising the steps of:
providing at least one communication device to communicate various states of the condition of the driver of the vehicle;
providing at least one sensor for detecting at least one characteristic of at least one of the driver and the vehicle, the at least one sensor generating a sensor signal representing the at least one characteristic of the at least one of the driver and the vehicle; and
controlling the at least one communication device based upon the at least one characteristic of the at least one of the driver and the vehicle to communicate the various states of the condition of the driver to other vehicles.

17. The system according to claim 16, wherein the at least one communication device includes an audible device configured to transmit an audible communication to the other vehicles.

18. The system according to claim 16, wherein the at least one communication device includes a visual device configured to transmit a visual communication to the other vehicles.

19. The system according to claim 16, wherein the at least one communication device includes a wireless transmission device configured to transmit a wireless communication to the other vehicles.

20. The system according to claim 16, wherein the at least one sensor detects at least one of a vision characteristic of the driver, a physiological biometric characteristic of the driver, a behavioral biometric characteristic of the driver, a steering system characteristic of the vehicle, a braking system characteristic of the vehicle, and an engine control system characteristic of the vehicle.
